(19) United States
(12) Patent Application Publication
(10) Pub. No.: US 2008/0260577 A1
(43) Pub. Date: Oct. 23, 2008

(54) CHEMILUMINESCENT DETECTION SYSTEM

(76) Inventors: Masataka SHIRAI, Higashimurayama (JP); Tomoharu Kajiyama, Higashiyamato (JP); Hideki Kambara, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/032,091

(22) Filed: Feb. 15, 2008

(30) Foreign Application Priority Data
Apr. 23, 2007 (JP) 2007-113095

(51) Int. Cl. G01N 21/76

(52) U.S. Cl. 422/52

(57) ABSTRACT

Throughput is improved by increasing the number of micro-reaction chambers. There is provided a chemiluminescent detection system that has a so-called plate on which many reaction chambers are one-dimensionally or two-dimensionally arranged, characterized in that optical detection is performed using a line or area sensor having many detection pixels, the spacing of the optical detection pixels substantially matches the spacing of the reaction chambers on the plate, and the micro-reaction chambers and the pixels are made to correspond one-to-one with each other so that light from the reaction chambers on the plate enters the detection pixels most efficiently and does not scatter to other pixels. To make the micro-reaction chambers arrayed on the plate and the pixels of the image pickup element plate correspond one-to-one with each other, light-emitting substances or reflectors or photoabsorption substances are placed so as to serve as alignment marks.

### CLAIM OF PRIORITY

The present application claims priority from Japanese application JP 2007-113095 filed on Apr. 23, 2007, the content of which is hereby incorporated by reference into this application.

### BACKGROUND OF THE INVENTION

1. Field of the Invention

The present invention relates to a chemiluminescent detection system, and more specifically, to one in which detection results of luminescence from a plurality of reaction chambers are used to analyze nucleic acid and analyze a base sequence of genes or the like.

2. Background Art

Methods using gel electrophoresis and fluorescence detection are widely used to determine a DNA base sequence. This method makes many copies of a DNA fragment to be subjected to an array analysis first. Fluorescently-labeled nucleic-acid fragments of various lengths are created using a 5′ end of DNA as a starting point. Moreover, fluorescent labels with different wavelengths are added according to the type of 3′ terminal base species of these DNA fragments. The difference in length is identified using gel electrophoresis by a difference of one base and luminescence emitted from each fragment group is detected. The type of DNA terminal base species of the DNA fragment group being measured is known from its luminescence wavelength color. Since DNA passes through the fluorescent detection section from a short fragment group one by one, it is possible to know the type of terminal base species from short DNAs one by one by measuring fluorescent colors. The array is determined in this way. Such a fluorescent DNA sequencer is widely used, and also has taken an active part in a human genome analysis a great deal. According to this method, a technique of increasing the number of genes analyzed and processes per unit using many glass capillaries having an inner diameter of approximately 50 μm and also using a method of terminal detection or the like is disclosed (e.g., see Non-Patent Document 1).

On the other hand, attention is being focused on an array decision method (e.g., see Patent Documents 1 and 2) by phased chemical reaction represented by a pyrosequence from the standpoint of convenience of handling. An outline of this is as follows. A primer is hybridized with a target DNA strand and four types of complementary strand synthesized nucleic acid substrates (dATP, dCTP, dGTP, dTTP) are added to a reactive liquid one type at a time to realize synthesis reaction of complementary strand. Once the synthesis reaction of complementary strand takes place, DNA complementary strands extend and pyrophoric acid (PPi) is generated as a by-product. The pyrophoric acid is converted to ATP by the functioning of coexisting enzyme, reacts under the coexistence of luciferin and luciferase and produces luminescence. It is understood by detecting this light that the added complementary strand synthesized substrates are taken into the DNA strand, and it is possible to know array information on the complementary strand, therefore array information on the target DNA strand.

This method enables high throughput by using a flow cell provided with many reaction chambers and an example where the number of genes analyzed and processes is greatly increased by applying the above described method is reported (e.g., see Non-Patent Document 2). In this application example, a flow cell that has a plurality of micro-reaction chambers on one side is used as a reaction plate. Many units in which target DNA strands are grouped by type and fixed to a sepharose bead of approximately 35 μm in diameter are prepared and approximately 10⁸ DNAs of the same type are fixed to each sepharose bead. After hybridizing the primer with these DNAs, one bead is put in each micro-reaction chamber. Moreover, the reaction chamber is filled with microparticles of 0.8 μm in diameter to which bioluminescent enzyme (luciferase) or the like is fixed. The filling of these beads is done by introducing a solution containing the bead into the flow cell and making it precipitate using a centrifuge. A DNA base sequence analysis is performed by successively introducing four types of complementary strand synthesized nucleic acid substrates (dATP, dCTP, dGTP, dTTP) for extension reaction from the flow cell upstream to realize synthesis reaction of complementary strand, but when the synthesis reaction of complementary strand progresses, pyrophoric acid is generated. The pyrophoric acid is converted to ATP and luciferase reaction takes place and bioluminescence produced in that case is observed. Some of devices that detect chemical luminescence and fluorescence using many such micro-reaction chambers are reported. Examples include a case where an anchor probe is fixed to one end face of a fiber optic plate instead of fixing DNAs to a bead, made to couple with a circular nucleic acid template and realize array determination and a multi-type analysis through bioluminescence (e.g., see Patent Document 2) and a case where the above described fiber optic plate is etched, the central portion of the fiber is removed and a reaction chamber is created, a multi-well titerplate (hereafter, abbreviated as “plate”) is constructed and used as part of the flow cell (e.g., see Non-Patent Document 3). Furthermore, for example, Patent Document 4 discloses a plate provided with a membrane or the like to reduce contamination by diffusion in the horizontal direction of matters generated in individual micro-reaction chambers in this plate or more specifically pyrophoric acid.
[Non-Patent Document 1] Anal. Chem. 2000, 72, 3423-3430
[Non-Patent Document 2] Margulies M, et al., “Genome sequencing in microfabricated high-density picolitre reactors.”, Nature, Vol. 437, Sep. 15, 2005, pp376-80, and Supplementary Information s1-s3
[Non-Patent Document 3] Electrophoresis 2003, 24, 3769-3777
[Patent Document 1] Internationally laid-open pamphlet No. 98/28440
[Patent Document 2] Internationally laid-open pamphlet No. 01/020039
[Patent Document 3] Internationally laid-open pamphlet No. 03/004690
[Patent Document 4] JP Patent Publication (Kohyo) No. 2003-515107 A

### SUMMARY OF THE INVENTION

These techniques detect luminescence from a reaction layer distributed on a plane by making it form an image in an area sensor using a coupling lens. In this case, since the image formed on the detector may be distorted or the position at which the image is formed may be relatively shifted, detection is generally performed with a plurality of detection pixels associated with one reaction chamber. Moreover, the number of reaction chambers should be set to from a fraction to one tenth of the number of pixels of the detector. Therefore, creating an apparatus provided with many reaction cells requires a very big image pickup element including an area sensor, which cannot help but result in an expensive apparatus.

On the other hand, a recessed part is made by etching an optical fiber and the recessed part can be used as a reaction chamber, too. In this case, there is also an attempt to couple an end of the fiber opposite to the reaction chamber provided at the end of the fiber with pixels of the area sensor. However, it is necessary to create an image pickup element and a reaction chamber as a single unit in this case, and there are disadvantages that this is not user-friendly and it is hard to control the temperature of the reaction chamber. Enzyme reaction is preferably realized at 35° C. or more, and this is because the image pickup element is preferably cooled for use because noise increases as the temperature of the image pickup element rises. Furthermore, since it is convenient that the reaction cell be made easily detachable because the reaction cell needs to be cleaned or disposed of according to circumstances. Furthermore, since an array of optical fibers is not completely regular, it is impossible to provide a one-to-one correspondence with the completely regularly arranged pixels over a wide area.

Moreover, Patent Document 4 also describes that fluorescence from a plurality of nucleic acids fixed to a nucleic acid chip is measured in one-to-one correspondence therewith.

However, there is no description on how the chip to which nucleic acids are fixed and the image pickup element are spatially (accurately) arranged, but in a system in which an inverted image is formed on a detection element through normal lens coupling, micro distortion of the image often has a considerable influence on the measuring result.

A pyrosequence analysis technique using a flow through detector made up of a plurality of micro-reaction chambers arranged in parallel has a short reading base length, but can achieve high throughput by increasing the number of reaction chambers compared with conventional gel electrophoresis. Under present circumstances in which array databases of various living things including a human genome array database are being put in order, if an array of many DNA fragments can be determined no matter how short the array may be, the influence on medical treatment and other fields is significant.

On the other hand, the number of feasible micro-reaction chambers is limited by the number of pixels of a semiconductor image pickup element in the case of chemiluminescent detection. The above described conventional technique performs detection with nine pixels associated with one reaction chamber and requires dummy pixels (pixels which do not need intensity of light received in the pixels as data) to further reduce crosstalk of signals. Moreover, the conventional technique can only use a reaction chambers corresponding in number to one tenth of pixels of the image pickup element (=solid-state element with many pixels formed on the same substrate). Actually, according to Non-Patent Document 2, the pixel size of a CCD that is an image pickup element is 15×15 μm and 480 micro-reaction chambers per square millimeter are measured using approximately 4500 pixels per square milimeter. That is, the number of micro-reaction chambers realized is approximately 1/10 of the number of pixels.

It is certainly possible to increase the number of micro-reaction chambers that can be measured by increasing the number of pixels of the image pickup element, but as described above, the image pickup element requires a large area, and not only the image pickup element becomes expensive but also the optical system to guide light to the image pickup element generally becomes expensive.

In this respect, it is understandable that throughput can be improved ten times if the number of pixels and the number of micro-reaction chambers are made equal.

However, to achieve this, the pixels and the reaction chambers need to be detected associated with each other and even if an image of a reaction chamber is formed in the area sensor by means of lens coupling as in the case of the conventional technique, this actually does not go well due to micro distortion of the lens (the detection accuracy is not good). Moreover, because the number of pixels of the image pickup element matches the number of reaction chambers, focus adjustment and alignment are essentially difficult even using a lens system with no distortion. In other words, it is difficult to make high throughput compatible with high detection accuracy.

Furthermore, as for the system shown in the conventional example in which a reaction chambers is constructed by etching one end of an optical fiber and causing the other end to closely contact the pixels of a detection element, it is not suitable for a system made detachable for replacement or cleaning of the reaction chamber. When the reaction chamber is constructed by etching one end of the optical fiber in this way, the position of the reaction chamber is determined by the position of the optical fiber, but the position of the optical fiber is not completely regular and it is difficult to make the position of the optical fiber correspond one-to-one with the pixels on the completely regularly arranged pixels on the image pickup element. Therefore, the development of new techniques which are different from these conventional examples is demanded.

Moreover, when the number of micro-reaction chambers is increased so as to substantially match the number of pixels on the image pickup element, positioning of the plate becomes important. That is, an apparatus that executes a pyrosequence analysis is provided with a plate wherein different arrays of nucleic acid of many types to be analyzed are fixed at different positions, an image pickup element for receiving light from the micro-reaction chambers thereon and an optical system for guiding luminescence from the plate to the image pickup element, but in this case, the image pickup and the relative position with respect to the optical system must be adjusted every time the plate is replaced. In this case, it is not possible to know beforehand at which part of the plate luminescence occurs and since the micro-reaction chambers on the plate are smaller than the resolution of the image pickup element, there is also a problem that focus, inclination and in-plane displacement of pixels cannot be adjusted so that the light from the micro-reaction chambers is condensed only on a specific pixel.

The present invention has been implemented in view of such circumstances and is intended to provide a pyrosequence analysis technique that can achieve high throughput at low cost and realize fluorescence detection with high accuracy.

In order to solve the above described problems, the chemiluminescent detection system according to the present invention uses optical means capable of forming images in a one-to-one correspondence of pixels with reaction chambers. Use of such optical means together with position control of the reaction chambers makes it possible to form one-to-one correspondence without distortion on the image pickup element. Furthermore, by providing a spatially separated lens system between the plate provided with the reaction chambers and the image pickup element, they are enabled to operate at mutually different temperatures. As such a lens system, for example, a rod lens array capable of forming an erecting image (normal image) or a micro lens array and optical fiber bundles can be used. The plate on which a plurality of micro-reaction chambers are regularly arranged based on a design, the image pickup element and the optical system are arranged at predetermined positions so that light from all the micro-reaction chambers can be detected by individual and corresponding pixels on the image pickup element. Especially, the reaction chambers, lens system, optical system, and image pickup element are arranged taking into account the temperature expansion coefficient of the plate in which the reaction chambers are formed so as to match the interval between the centers of images of the micro-reaction chambers on the image pickup element with the interval between the centers of pixels of the image pickup element when adjusted to an optimum temperature for chemical reaction produced in the reaction chambers.

That is, the chemiluminescent detection system according to the present invention is a chemiluminescent detection system that detects light from a plurality of reaction chambers and includes a flow cell that has a plate on which a plurality of reaction chambers are one-dimensionally or two-dimensionally arranged, optical detection means having a plurality of pixels, the interval of pixels of the optical detection means substantially matching the interval of the reaction chambers on the plate, and an optical system for forming images of the plurality of reaction chambers in the optical detection means. Luminescence of each of the plurality of reaction chambers is detected in a one-to-one correspondence with different pixels in the optical detection means. Such a function may also be provided that DNA samples are fixed to beads and stored in the plurality of reaction chambers individually and synthesis reaction of complementary strand is executed in such a condition to enable luminescence reaction to be produced continuously.

Furthermore, the present chemiluminescent detection system includes means for adjusting, after the plate provided with the reaction chambers is arranged, relative positions of the lens system, image pickup element and optical system. This adjusting means is constructed of an illuminant, reflector or light transmitter on the plate for making images correspond one-to-one with pixels on the image pickup element of the reaction chamber and intended to adjust the position and angle of the plate based on the detection result of light.

To measure luminescence from the reaction chambers most efficiently at pixels in a one-to-one correspondence with the reaction chambers, the luminescence area of the reaction chamber (size of the reaction chamber) is configured so as to be smaller than the pixel area. Moreover, in order to measure luminescence from the reaction chambers most efficiently at pixels in a one-to-one correspondence with the reaction chambers, a reflection coating may be formed in the inner wall of the reaction chambers so as to improve the optical radiation efficiency of upward luminescence and measure light from the top surface of the plate efficiently.

Moreover, it is also possible to arrange two-dimensionally arrayed reaction chambers using a line sensor made up of one-dimensionally arrayed pixels in such a way that the reaction chambers arrayed in a direction parallel to the array direction of the pixels of the line sensor are made to correspond one-to-one with the pixels and the plate is relatively moved with respect to the image pickup element so as to enable chemical luminescence from the two-dimensionally arrayed reaction chambers to be measured.

According to the present invention, it is possible to realize a chemiluminescent detection system capable of performing fluorescence detection for a pyrosequence analysis at low cost and with high throughput and high accuracy.

Further features of the present invention will be made clear with preferred embodiments for implementing the present invention and attached drawings which will be described below.

### BRIEF DESCRIPTION OF THE DRAWINGS

FIG. 1 shows a schematic configuration of a chemiluminescent detection system according to a first embodiment;

FIG. 2 is a schematic configuration diagram of a flow cell;

FIG. 3 is a cross-sectional view of the flow cell;

FIG. 4 is a graph showing a relationship between magnification and photoreception efficiency per pixel;

FIG. 5 shows a schematic configuration of a chemiluminescent detection system according to a second embodiment;

FIG. 6 is a schematic configuration diagram of a multi-well titerplate;

FIG. 7 shows a schematic configuration of a chemiluminescent detection system according to a third embodiment;

FIG. 8 is a cross-sectional view of the flow cell;

FIG. 9 illustrates an example of a multi-well titerplate used in the third embodiment;

FIG. 10 illustrates a positional relationship between reaction chambers and pixels on the multi-well titerplate;

FIG. 11 is a flow chart illustrating a procedure for position and the focus adjustment;

FIG. 12 is a diagram that defines the angle of the plate;

FIGS. 13(A)-13(C) are cross-sectional views of an example of the multi-well titerplate that has luminous points;

FIG. 14 shows a schematic configuration of a chemiluminescent detection system having a reflector as aluminous point according to the third embodiment;

FIG. 15 illustrates lighting positions (1);

FIG. 16 illustrates lighting positions (2);

FIG. 17 illustrates lighting positions (3);

FIG. 18 illustrates lighting positions (4);

FIG. 19 is a cross-sectional view when a fiber optic plate is used;

FIG. 20 is a schematic diagram of a plate when luminous points are positioned between micro-reaction chambers (fourth embodiment);

FIG. 21 is a plot (1) of a contrast function with respect to displacement and resolution;

FIG. 22 is a plot (2) of a contrast function with respect to displacement and resolution;

FIG. 23 shows a positional relationship (1) between micro-reaction chambers and luminous points; and

FIG. 24 shows a positional relationship (2) between micro-reaction chambers and luminous points.

FIG. 25 is a graph on the resolution of contrast and the amount of in-plane displacement shown in FIG. 21; and

FIG. 26 is a graph on the resolution of contrast and the amount of in-plane displacement shown in FIG. 22.

### DETAILED DESCRIPTION OF THE PREFERRED EMBODIMENTS

Hereafter, embodiments of the present invention will be explained with reference to the attached drawings. However, it should be noted that the embodiments are merely examples for implementing the present invention and are not intended to limit the present invention. Moreover, components common among drawings will be assigned the same reference numerals.

### First Embodiment

### (1) Configuration of Chemiluminescent Detection System

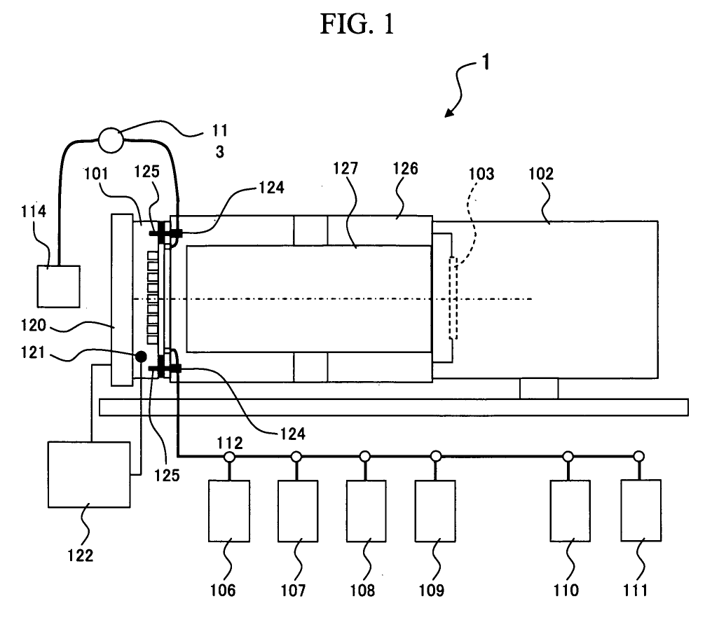

FIG. 1 shows a schematic configuration of a chemiluminescent detection system 1 according to a first embodiment of the present invention. This is an example where the chemiluminescent detection system 1 detects chemical luminescence emitted from a reaction chamber plate by creating a one-to-one erecting image in an image pickup element using a rod lens array. Even if micro-reaction chambers (micro-reaction cells) are arranged within a wide range on the plate, the use of the rod lens array makes the micro-reaction chambers correspond one-to-one with pixels of the image pickup element, and can thereby form images of chemical luminescence from the micro-reaction chambers in the image pickup element. Furthermore, the rod lens array forms an erecting image of 1× magnification in the image pickup element, can most efficiently form images of luminescence from the micro-reaction chambers in the image pickup element and at the same time suppress influences of displacement of the micro-reaction chambers due to expansion, shrinkage or distortion of the plate to a minimum instead of expanding such influences on the images. The array of genes to be measured is determined by using the principle of a pyrosequence method.

In FIG. 1, the chemiluminescent detection system 1 as a system that measures chemical luminescence from the micro-reaction chambers in a flow cell is provided with the flow cell 101, a two-dimensional image pickup camera 102 which is a detection section such as a cooling type CCD camera that detects a luminescence image, a rod lens array 127 that can obtain an erecting image at 1× magnification as an optical system that forms images of luminescence from the micro-reaction chambers in a (two-dimensional) image pickup element 103 inside the camera, and a lens holder 126 to fix the arrangement of this rod lens array 127 and image pickup element 103. The use of this rod lens array 127 eliminates distortion of the images of luminescence and realizes a one-to-one relationship between the micro-reaction chambers and pixels of the image pickup element.

Furthermore, the chemiluminescent detection system 1 is constructed of reagent chambers 106 to 109 that contain four types of nucleic acid substrate (dATP, dGT, dCTP, dTTP) to dispense a reagent into the flow cell one by one as a system that sends a solution of the reagent to the micro-reaction chambers, a cleaning reagent chamber 110 that contains a cleaning reagent for cleaning the inside of the flow cell after measurement of extension reaction, a conditioning reagent chamber 111 that contains a conditioning reagent to flush the remaining cleaning reagent component in the cell after cleaning, an injection section for selectively injecting the reagents into the flow cell (selection valve 112 and pump 113 to handle the reagents) and a waste fluid bottle 114 or the like. The chemiluminescent detection system 1 is further provided with a Peltier element 120 for setting the temperature of a reagent solution in the flow cell to an optimum temperature for a pyrosequence, a thermistor as a temperature sensor, and a temperature controller 122 for controlling an electric current to be flown into the Peltier element from the temperature measured with the thermistor. Moreover, the system is cooled down to −20° C. to decrease noise by a dark current of the image pickup (CCD) element 103. This cooling temperature is determined according to the intensity of chemical luminescence and the intensity of background luminescence which does not derive from an extension of target DNA, but is generally set to a room temperature or below. On the other hand, the temperature of the plate controlled by the Peltier element 120 is set to an optimum temperature for chemical luminescence, 40° C. here. This temperature also varies depending on enzyme used, but is generally set to the room temperature or above.

### (2) Structure of Flow Cell

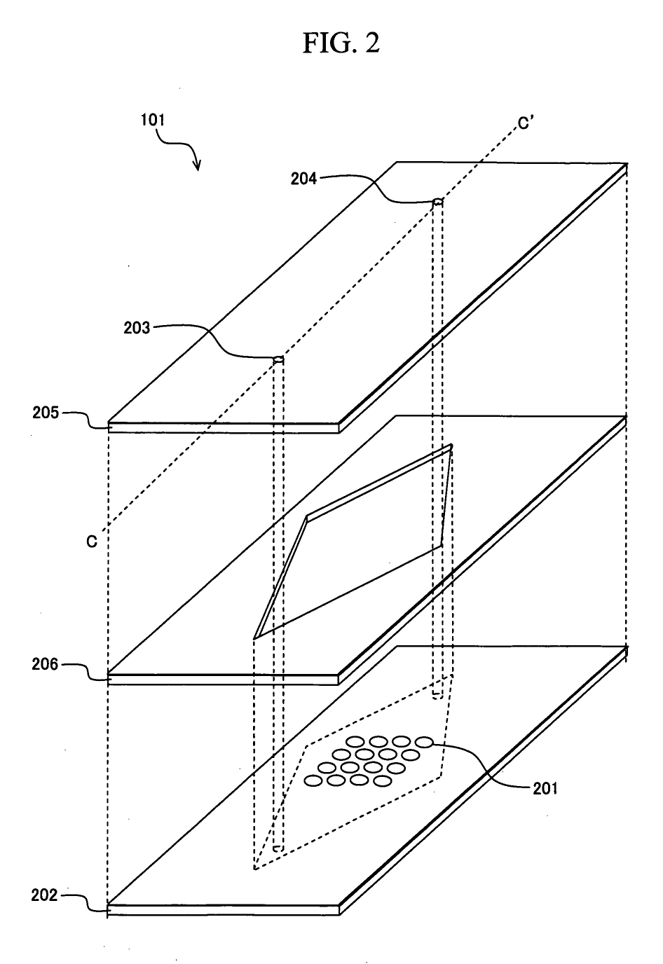

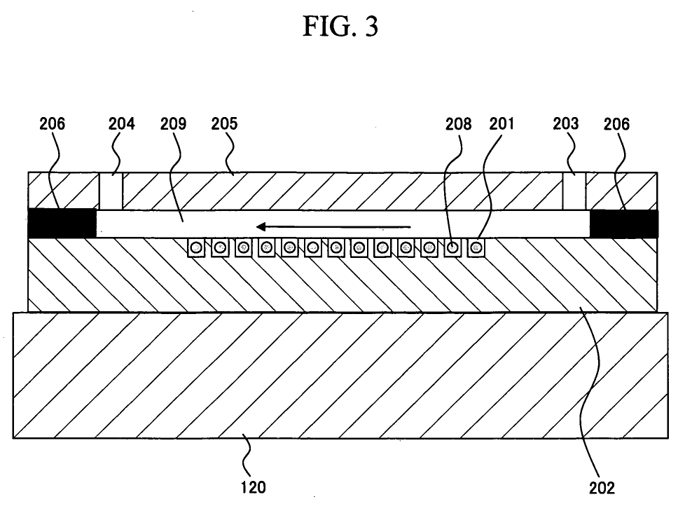

Next, the structure of the flow cell 101 will be explained with reference to FIG. 2. The flow cell 101 is provided with a (multi-well titerplate) plate 202 having, on the surface thereof, a plurality of micro-reaction chambers (concave parts) 201 for holding sample fixing beads which will be described later, a reagent inflow port 203, a reagent exhaust port 204, a top plate 205 provided with a sample slot (not shown) as required, and a spacer 206 that forms a channel. FIG. 3 shows a cross-sectional view along CC′ of the flow cell 101. In FIG. 3, a reagent flows through a channel 209 formed between the top plate 205 and plate 202, and a necessary reagent is supplied into the micro-reaction chambers 201 in this case. Beads 208 to which DNAs to be analyzed are fixed are inserted into the micro-reaction chambers 201.

The shape of the micro-reaction chambers 201 is preferably columnar, for example. The shape is determined depending on the material and the manufacturing method of the substrate. Various plates can be used such as a plate manufactured through cutting using a stainless steel material as a substrate, a plate manufactured through a mask and wet etching using a silicon wafer, a plate manufactured through a bluster process with particles using glass such as slide glass and a plate manufactured through injection molding of a metal mold using polycarbonate, polypropylene, polyethylene or the like. However, these are by no means intended to limit the material and manufacturing method of the micro-reaction layer.

Furthermore, for example, the flow cell 101 used includes 4096×4096 micro-reaction chambers formed at intervals of 15 μm in a square area, 6.144 cm on a side on the plate 202. When the plate 202 is formed using glass, for example, it must be created by taking into account thermal expansion due to the difference in the temperature when the micro-reaction chambers are formed and the temperature (40° C.) when the plate is installed and chemical luminescence is measured. That is, the temperature of the micro-reaction chambers is set to 20° C. and 4096×4096 micro-reaction chambers are formed in an area smaller by 9.8 μm than 6.144 cm. Furthermore, when polycarbonate is used, molding is performed at 200° C. using a metal mold, and the square area in which the micro-reaction chambers are arranged on the metal mold is manufactured to be greater by 368.6 μm than 6.144 cm and used as the metal mold. Thus, by manufacturing the system with thermal expansion and contraction coefficients of the plate taken into consideration, it is possible to reliably realize the one-to-one correspondence between the micro-reaction chambers and pixels at the time of detection.

### (3) Features of Image Pickup Element

Next, the image pickup element 103 will be explained. The image pickup element 103 may be any area sensor which is a two-dimensional image pickup element or any line sensor which is a one-dimensional image pickup element as long as it is a light receiving element provided with many pixels. However, it is effective to use either a CCD (Charge Coupled Device) with low transfer noise of data or a CMOS sensor whose manufacturing cost is low. In this case, the image pickup element may be preferably cooled electronically to reduce dark current noise. Actually, measurement is performed using the CCD element at an element temperature of −20° C. or less.

Furthermore, when the pixel size increases, not only the element cost increases, but also it is not possible to produce the image pickup element with many pixels from the standpoint of manufacturing yield. Therefore, the pixel size is preferably set to 15 μm in both cases of CCD and CMOS. Furthermore, the array format of pixels is generally tetragonal lattice or rectangular lattice, but the array format may also be hexagonal lattice or a honeycomb structure combining an octagon and square. In this case, the micro-reaction chambers also need to be arrayed in the same manner. This embodiment adopts tetragonal lattice.

Since the arrangement cycle of the pixels of the image pickup element 103 should match the arrangement cycle of the micro-reaction chambers 201, the micro-reaction chambers 201 are preferably made smaller than the pixels of the image pickup element 103. However, when the size of the micro-reaction chambers 201 is reduced and the spacing between the micro-reaction chambers 201 is reduced, Ppi or ATP that becomes the substrate of chemical luminescence diffuses within an exposure time, making it difficult to make a distinction from luminescence of the adjoining micro-reaction chambers 201. Therefore, the spacing between the micro-reaction chambers 201 and the pixel size determined therefrom should be longer than the length determined from the diffusion distance. This length is approximately 1 μm. On the other hand, when the pixel size is made greater than a predetermined size, the size of the whole image pickup element made up of a CCD or CMOS sensor manufactured on a semiconductor substrate increases, which becomes unrealistic not only from the standpoint of cost but also from the standpoint of manufacturing yield. The pixel size which constitutes a limit within which the size of the whole image pickup element can be increased is approximately 30 μm. Therefore, when the semiconductor image pickup element such as CCD or CMOS sensor is used, the pixel size should preferably be set to 1 μm to 30 μm.

In the case of a flat panel display whose element is formed on a glass substrate, an increase of the pixel size is not led to any cost increase, but there is a limitation to cooling thereof. Therefore, it is preferable to set 30 μm to 150 μm as the pixel size.

### (4) Features of Optical System

As described above, this embodiment uses the rod lens array 127 as the optical system. With the rod lens array 127, one lens is realized by increasing the refractive index in the central portion of the columnar glass compared with that of the surrounding portion. An array is formed by one-dimensionally or two-dimensionally arranging these columns in such a way the columns erect in a direction perpendicular to the surface of image. According to this embodiment, the diameter of the columnar lens making up the rod lens array is, for example, 1.115 mm and the length thereof is 8.42 mm. Furthermore, the array is constructed by arranging 60×60 (3600) such columnar lenses in consideration of peripheral effects, too.

The images of the micro-reaction chambers are designed to be formed in the image pickup element when the distance between the rod lens array 127 and micro-reaction chambers 201 matches the distance between the image pickup element 103 and rod lens array 127. This distance is generally several millimeters. The rod lens array 127 used here has this distance of 4.2 mm. In this way, by obtaining images with a certain distance kept between the plate 202 and rod lens array 127, it is possible to provide the channel for a reagent 209 between the micro-reaction chamber 201 and rod lens array 127 as shown in FIGS. 1 and 3. Forming this channel 209 eliminates the necessity for creating a structure to enable luminescence to be decomposed for each micro-reaction chamber 201 in the plate 202 for measurement. Therefore, forming this channel 209 is a factor indispensable for manufacturing the low-cost plate 202. Furthermore, such an arrangement, that is, arranging the lens array 127 and micro-reaction chambers 201 facing each other across the channel 209 and forming a reflector (not shown) of a metallic film or the like in the inner wall of the micro-reaction chambers 201, makes it possible to improve the light-receiving efficiency of luminescence and improve sensitivity. Here, for example, gold may be vapor-deposited to a film thickness of 3 μm on the inner wall of the micro-reaction chambers 201 so as to enable several tens % of light emitted opposite to the image pickup element 103 to be emitted toward the image pickup element 103. Furthermore, setting the magnification of the image to 1× is a condition that allows light to be taken into the pixels of the image pickup element 103 most efficiently. However, in the case of the rod lens array 127, since light beams from a plurality of columnar lenses superimpose on each other to form one image, an effective F value is 0.7 or below, capable of obtaining a very clear image. Moreover, because both the focal depth and depth of field of this rod lens 127 are approximately 0.3 mm, these depths are greater than the depth of micro-reaction chambers 201 and luminescence from the micro-reaction chambers 201 can be imaged more deeply as a two-dimensional image.

### (5) Alignment of Flow Cell (Plate)

To make the micro-reaction chambers 201 correspond one-to-one with the pixels of the image pickup element 103, the positions of the plate 202, the optical system (rod lens 127) and the image pickup element need to be adjusted with high accuracy. The configuration and method for realizing this adjustment will be explained below.

As shown in FIG. 1, the rod lens array 127 is fixed to the lens holder 126. Concave parts 124 are formed in the lens holder 126 as a plurality of match marks. Convex parts 125 (engagement pins) as match marks fixed to the plate 202 in which the micro-reaction chambers 201 are formed are engaged with the concave parts. With the plate 202 put in place, the image pickup element 103 is fixed to the lens holder 126 after the image pickup element 103 is aligned so that the micro-reaction chambers 201 correspond one-to-one with the pixels. In this case, the plate 202 fixed in the flow cell 101 needs to be removed, but by providing the engagement pins 125 in the plate 202 and engaging the engagement pins 125 with the concave parts 124, it is possible to always make the micro-reaction chambers 201 correspond one-to-one with the pixels and obtain images of luminescence even when the plate 202 and flow cell 101 are detached or attached.

In this embodiment, alignment between the flow cell 101 and image pickup element 103 is performed when the system is manufactured. As described above, the flow cell 101 and image pickup element 103 are enabled to be mechanically aligned through the convex parts 125 and concave parts 124 during operation. In a word, a dummy plate is prepared in which pinholes of approximately 1 μm in diameter are perforated at positions corresponding to several micro-reaction chambers 201 when the chemiluminescent detection system 1 is manufactured. By fixing the dummy plate to the lens holder 126 and irradiating the dummy plate with light from the back, light-emitting points can be arranged at positions corresponding to the micro-reaction chambers 201. The image pickup element 103 is aligned to allow these light-emitting points to be measured by the corresponding pixels and the image pickup element 103 is fixed. Furthermore, the temperature of this plate 202 and the temperature of the CCD or the like are set to the above described operating temperatures and adjustment is performed. Furthermore, the lens holder 126 is preferably made of glass (quartz) so as not be distorted by variations in the ambient temperature.

### (6) Size of Micro-Reaction Chamber

Suppose the diameter of the micro-reaction chambers 201 is 12 μm, depth is 12 μm and the spacing between the micro-reaction chambers 201 is 3 μm. In this case, the accuracy of alignment of the image pickup element 103 with respect to the plate 202 is preferably half or less than the above described spacing, that is, 1.5 μm or less.

### (7) Others

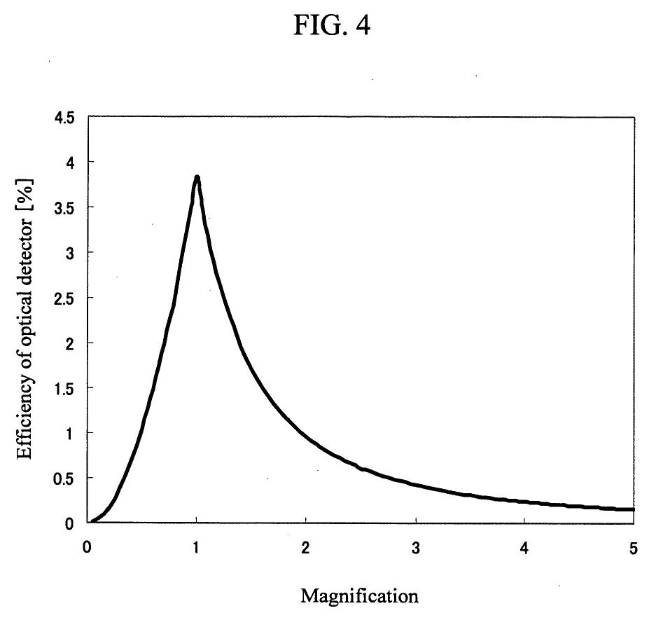

This embodiment uses a rod lens 127 whose F value is 1 at a 1× magnification, and generally, when a lens system having a fixed F value is used for image formation, the magnification for guiding light from a micro-reaction chamber to a pixel most efficiently is 1×. This is shown in FIG. 4. In FIG. 4, the vertical axis shows light-receiving efficiency of one pixel and the horizontal axis shows magnification. The size of the micro-reaction chamber 201 is smaller than the pixel size of the image pickup element 103 and the spacing between micro-reaction chambers should match the spacing between pixels on a real scale. Therefore, the diameter of the micro-reaction chamber 201 is made smaller than the length of one side of the pixel to make the micro-reaction chambers 201 correspond one-to-one with the pixels of the image pickup element 103 so as to be able to receive chemical luminescence with highest sensitivity.

A two-dimensional (area) sensor is used as the image pickup element here, but a one-dimensional (line) sensor may also be used.

### Second Embodiment

### (1) Configuration of Chemiluminescent Detection System

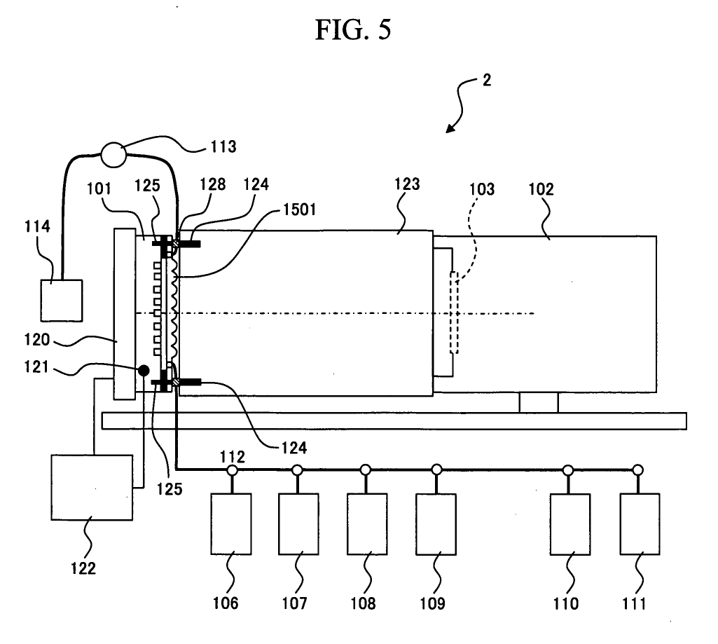

FIG. 5 shows a schematic configuration of a chemiluminescent detection system 2 according to a second embodiment of the present invention. The chemiluminescent detection system 2 is an example using an optical fiber bundle 123 instead of the rod lens array 127 used for the optical system for image formation in the first embodiment. The chemiluminescent detection system 2 has a configuration similar to that of the first embodiment except the optical system.

The optical fiber bundle 123 is made up of many optical fibers having a minimal diameter bundled together and fixed and causes images of luminescence from micro-reaction chambers 201 in the vicinity of one end face to be formed in the vicinity of the other end face. As in the case of the rod lens array 127, the optical fiber bundle can make all the micro-reaction chambers 201 correspond one-to-one with pixels of an image pickup element 103 if only aligned adequately without any distortion of images even in the periphery. However, in the case of the optical fiber bundle 123, resolution is limited depending on the diameter of the bundled optical fiber.

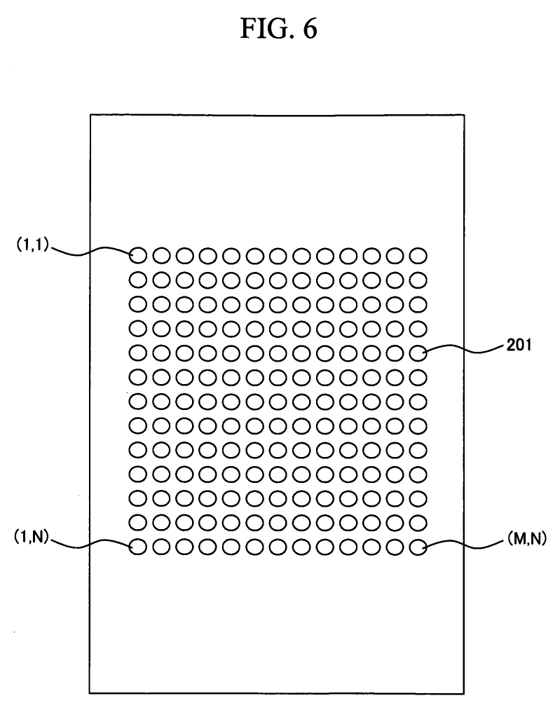

Furthermore, in order to directly take in light from the micro-reaction chambers 201 using the optical fiber bundle 123 in the positional relationship between a plate 202 of a flow cell 101 and the image pickup element 103 as shown in FIG. 6, the micro-reaction chambers 201 need to be brought extremely close to the end face of the optical fiber bundle 123. For this reason, there is neither channel for supplying a reagent to the micro-reaction chambers 201 nor space in which to arrange a top plate 205 of the flow cell 101. A micro lens array 1501 is provided to solve such a problem and drastically improve the efficiency of taking in chemical luminescence at the same time. The micro lens array 1501 is arranged on the top plate 205 of the flow cell 101.

### (2) Features of Optical System

This micro lens array 1501 corresponds one-to-on with the micro-reaction chambers 201, is fixed to the plate 202 and also corresponds one-to-on with the pixels. Moreover, the focal plane of the optical fiber bundle 123 is designed and arranged so that the image of a rear principal point of the micro lens array 1501 (principal point on the image side) is formed in the image pickup element 103. The diameter w of the micro-reaction chamber 201 is set to 10 μm, depth d to 10 μm, channel height h to 5 μm, and distance s between the front principal point of the micro-array lens (principal point on the object side) and the surface of the lens on the channel side to 10 μm. Moreover, the diameter R of one lens making up the micro lens array 1501 is set to 15 μm and these lenses of the micro lens array 1501 are arranged on a tetragonal lattice at intervals of 15 μm in a one-to-one correspondence with the pixels of the image pickup element. Furthermore, the micro lens used has a focal length f of 20 μm. f is determined according to s+h+d/2. By making the focal length f as small as possible under the condition of R>w, it is possible to receive bioluminescence generated in the micro-reaction chambers more efficiently than when it is condensed using an ordinary camera lens.

A camera lens may be used instead of the optical fiber bundle 123, but there is a problem with distortion of images in this case. Therefore, it can be said to be preferable to use the optical fiber bundle 123.

Furthermore, as an optical system, an optical fiber bundle that bundles optical fibers having a diameter of 3 μm is used.

### (3) Alignment of Flow Cell (Plate)

The optical fiber bundle 123 and the image pickup element 103 are fixed. On the other hand, the flow cell 101 can be detached from the chemiluminescent detection system 2. In this case, the positions of the optical fiber bundle 123 and the image pickup element 103 are adjusted and fixed appropriately according to the following procedure. That is, concave parts 124 are formed as a plurality of match marks in the optical fiber bundle 123. Convex parts 125 (engagement pins) are attached to the plate 202 as fixed match marks. With the plate 202 attached, the micro-reaction chambers and the image pickup element 103 are aligned so as to face each other, and then the image pickup element 103 is fixed to the optical fiber bundle 123. Moreover, the focal plane of the optical fiber bundle 123 is defined by a spacer 128. By engaging the engagement pins 125 fixed to the plate 202 with the concave parts 124 in the optical fiber bundle 123, the micro-reaction chambers in the plate 202 and the pixels of the image pickup element 103 can be aligned in a one-to-one correspondence. In this case, a pyrosequence may be conducted in the flow cell 101 to align with the image pickup element 103.

The alignment between the flow cell 101 and the image pickup element 103 may also be performed when the system is manufactured. As described above, in operation, the system is designed to be able to realize mechanical alignment using the convex parts 125 and concave parts 124. In a word, a dummy plate is prepared with pinholes of approximately 1 μm in diameter perforated at positions corresponding to several micro-reaction chambers 201 when the chemiluminescent detection system 1 is manufactured. By fixing the dummy plate and irradiating the dummy plate with light from the back, light-emitting points can be arranged at positions corresponding to the micro-reaction chambers 201. The image pickup element 103 is aligned to allow these light-emitting points to be measured by the corresponding pixels and the image pickup element 103 is fixed. Furthermore, the temperature of this plate 202 and the temperature of the CCD or the like are set to the above described operating temperatures and adjustment is performed.

### (4) Others

This embodiment uses an optical fiber bundle to form images of chemical luminescence on the plate in a CCD. This is because the optical fiber bundle reduces distortion of the image and reduces the possibility that spacing between images of the micro-reaction chambers may be widened or narrowed in the central and peripheral parts of the images.

A two-dimensional (area) sensor is used as the image pickup element, but a one-dimensional (line) sensor may also be used.

Because the structure of the flow cell and the features of the image pickup element are similar to those of the first embodiment, explanations thereof will be omitted.

### Third Embodiment

In the above described first and second embodiments, alignment of the flow cell 101 is performed during manufacturing so as to eliminate the necessity for alignment when the flow cells 101 is replaced (during operation). However, when the work accuracy of the flow cell 101 is not enough, alignment is needed every time the flow cell 101 is replaced. Therefore, the third embodiment provides a chemiluminescent detection system having a configuration that allows alignment of the flow cell 101 in operation of the system.

### (1) Configuration of Chemiluminescent Detection System

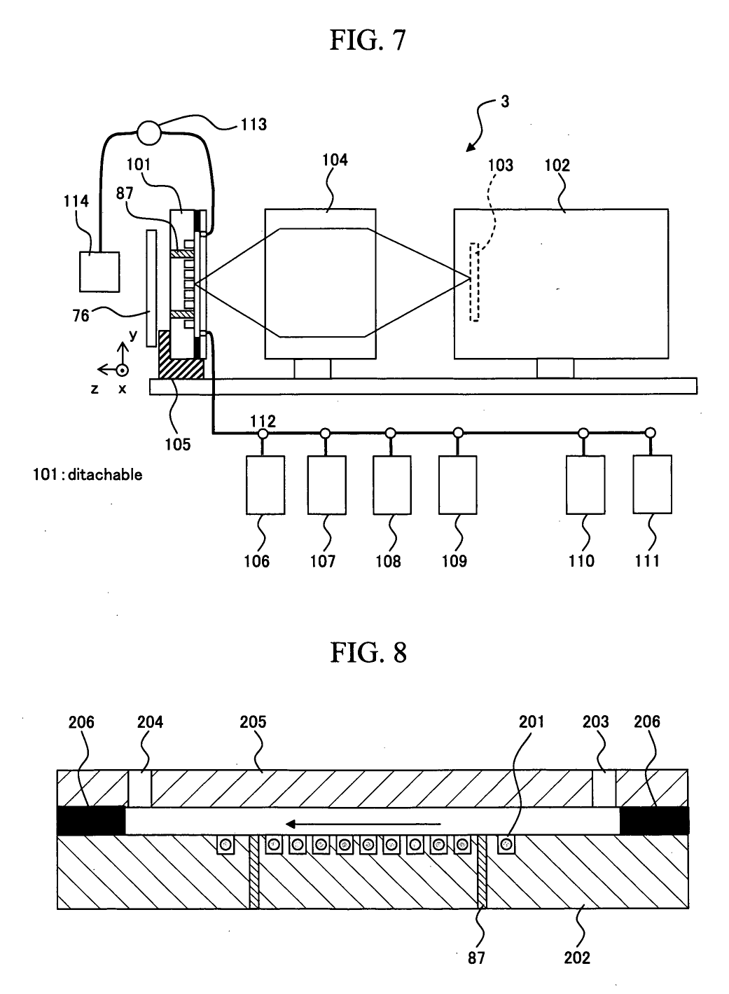

FIG. 7 shows a schematic configuration of a chemiluminescent detection system 3 according to a third embodiment. The chemiluminescent detection system 3 is provided with a flow through type cell (flow cell) 101, a two-dimensional image pickup camera 102 which is a detection section that detects images of luminescence such as a cooling type CCD camera, a lens system 104 for forming images of luminescence from micro-reaction chambers 201 in the two-dimensional image pickup element 103 inside the camera at an appropriate magnification, reagent chambers 106 to 109 that store four types of nucleic acid substrate (four types of dATP, dGT, dCTP, dTTP or the like) to be dispensed to the reaction chambers (cells) one by one, a cleaning reagent chamber 110 that stores a cleaning reagent for cleaning the inside of the flow cell after measurement of extension reaction, a conditioning reagent chamber 111 that stores a conditioning reagent to flush the remaining cleaning reagent component in the cells after cleaning, an injection section to selectively inject the reagents into the flow cell (selection valve 112, pump 113 to handle the reagent), and a waste fluid bottle 114. Here, the lens 104 is moved in the z-axis direction out of the x, y and z axes shown in the figure so that the micro-reaction chambers 201 in the flow cell 101 correspond one-to-one with pixels of an image pickup element 103, the magnification is adjusted, the flow cell 101 is moved in the x-, y- and z-axis directions of movement by an alignment mechanism 105 and the focus and the position of an image are adjusted.

### (2) Structure of Flow Cell

As in the case of the first embodiment, the flow cell 101 has the structure shown in FIG. 2. As shown in FIG. 2, the flow cell 101 is constructed of a (multi-well titerplate) plate 202 having a plurality of micro-reaction chambers (concave parts) 201 for holding sample fixing beads which will be described later, a reagent inflow port 203, a reagent exhaust port 204, a top plate 205 provided with a sample slot (not shown) as required, and a spacer 206 that forms a channel. FIG. 8 shows a cross-sectional view along CC′ (see FIG. 2) of the flow cell 101. The reagent flows between the top plate 205 and the plate 202 and a necessary chemical substance is supplied into the micro-reaction chambers 201 in this case. Moreover, luminescence from the micro-reaction chambers is received by the image pickup element 103 through the transparent top plate 205. Reference numeral 87 in the figure denotes a light transmission window corresponding to a light-emitting point for alignment. Details of the light transmission window 87 will be described later.

### (3) Features of Image Pickup Element

The image pickup element 103 may be any area sensor which is a two-dimensional image pickup element or any line sensor which is a one-dimensional image pickup element as long as it is a light receiving element provided with many pixels. For example, it is effective to use either a CCD (Charge Coupled Device) with low transfer noise of data or a CMOS sensor whose manufacturing cost is low. In this case, the image pickup element needs to be electronically cooled to reduce dark current noise. Actually, measurement is performed using the CCD element at an element temperature of −20° C. or less.

Furthermore, when the pixel size increases, not only the element cost increases, but also it is not possible to produce the image pickup element 103 with many pixels from the standpoint of manufacturing yield. Therefore, the pixel size is preferably set to 20 μm or less in both cases of CCD and CMOS. Furthermore, the pixel array format is generally tetragonal lattice or rectangular lattice, but the pixel array format may also be hexagonal lattice or a honeycomb structure combining an octagon and a square. In this case, the micro-reaction chambers also need to be arrayed in the same manner. This embodiment adopts tetragonal lattice.

### (4) Structure of Multi-Well Titerplate

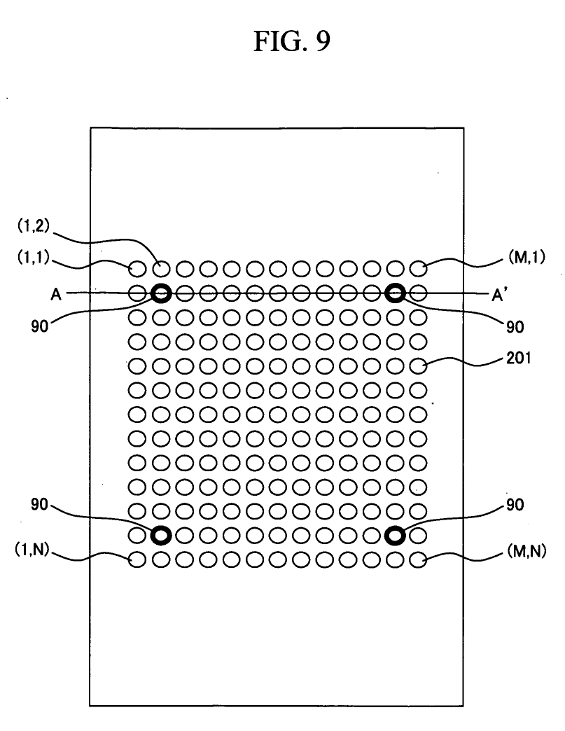

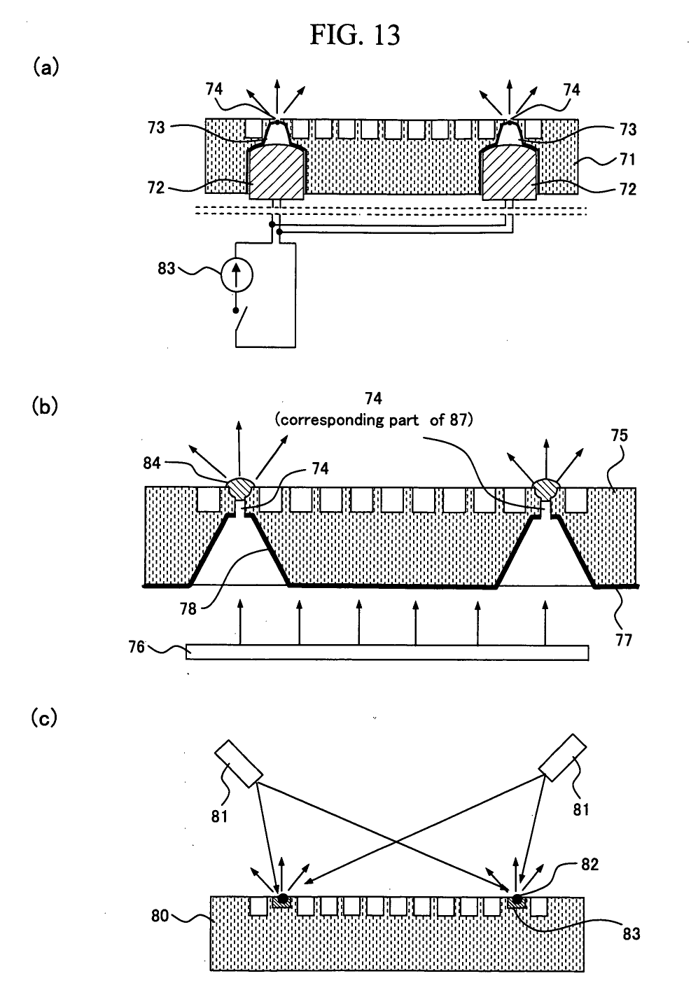

FIG. 9 shows an example of the multi-well titerplate 202. This plate 202 has a plurality of micro-reaction chambers 201 in the central part. In this example, the reaction layer 201 is arranged like a tetragonal lattice in the form of a square. Light-emitting points 90 are arranged in the vicinity of the four corners of this square (see FIG. 13 for details). Light from the light-emitting points 90 is radiated isotropically and images are formed by the lens 104 in the image pickup element (CCD) 103.

The shape of the micro-reaction chamber 201 is preferably columnar, for example. The shape is determined depending on the material and the manufacturing method of the substrate. Various plates can be used such as a plate manufactured through cutting using a stainless steel material as a substrate, a plate manufactured through a mask and wet etching using a silicon wafer, a plate manufactured through a bluster process by means of particles using glass such as slide glass and a plate manufactured through injection molding of a metal mold using polycarbonate, the polypropylene and polyethylene or the like. However, these are by no means intended to limit the material and manufacturing method of the micro-reaction layers.

### (5) Alignment of Flow Cell (Plate)

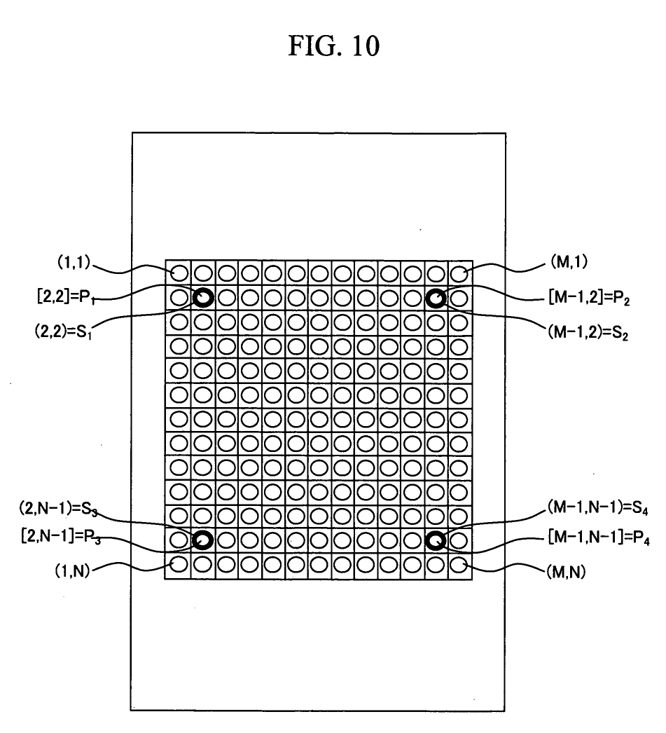

FIG. 10 shows a relationship between images of the two-dimensional image pickup element 103 in the micro-reaction chambers 201 and the pixels. The images of the micro-reaction chambers 201 are smaller than those of the pixels, and the micro-reaction chambers 201 correspond one-to-one with the pixels. In this example, both the number of micro-reaction chambers 201 and pixels are M×N. The micro-reaction chambers 201 and the pixels are labeled from the top left as (k, l) and [k, l] (k=1 . . . M, 1 . . . N) respectively. Four light-emitting points are formed at the positions of coordinates of (2, 2), (M−1, 2), (2, N−1) and (M−1, N−1) on the multi-well titerplate 202 and they are denoted as S₁, S₂, S₃ and S₄. Moreover, the central positions of the corresponding pixels [2, 2], [M−1, 2], [2, N−1] and [M−1, N−1] are denoted as P₁, P₂, P₃ and P₄ respectively. In this case, when the images at light-emitting points Sᵢ (i=1 . . . 4) in the image pickup element (CCD) 103 are assumed to be four images (Q₁, Q₂, Q₃, Q₄), alignment and focus adjustment of the plate 202, that is, flow cell 101, can be achieved by causing the center of Pᵢ to match the center of Qᵢ and causing the size of Qᵢ to match the size of Sᵢ. In this embodiment, since the size of Sᵢ is smaller than the size of the pixel, alignment and focus adjustment can be set to an appropriate state by aligning Pᵢ with Qᵢ and maximizing the contrast corresponding to Qᵢ at Pᵢ. The contrast corresponding to Qᵢ is defined by Formula 1.

### [Formula 1]

$$\begin{matrix}Formula 1 & \\ Contranst 1 ( {Q}_{i} ) = {Max}_{[ k , l ] ∈ Ri} ( \begin{matrix}\vert I [ k , l ] - I [ k - 1 , l ] \vert + \vert I [ k , l ] - I [ k + 1 , l ] \vert + \\ \vert I [ k , l ] - I [ k , l - 1 ] \vert + \vert I [ k , l ] - I [ k , l + 1 ] \vert\end{matrix} ) & ( 1 )\end{matrix}$$

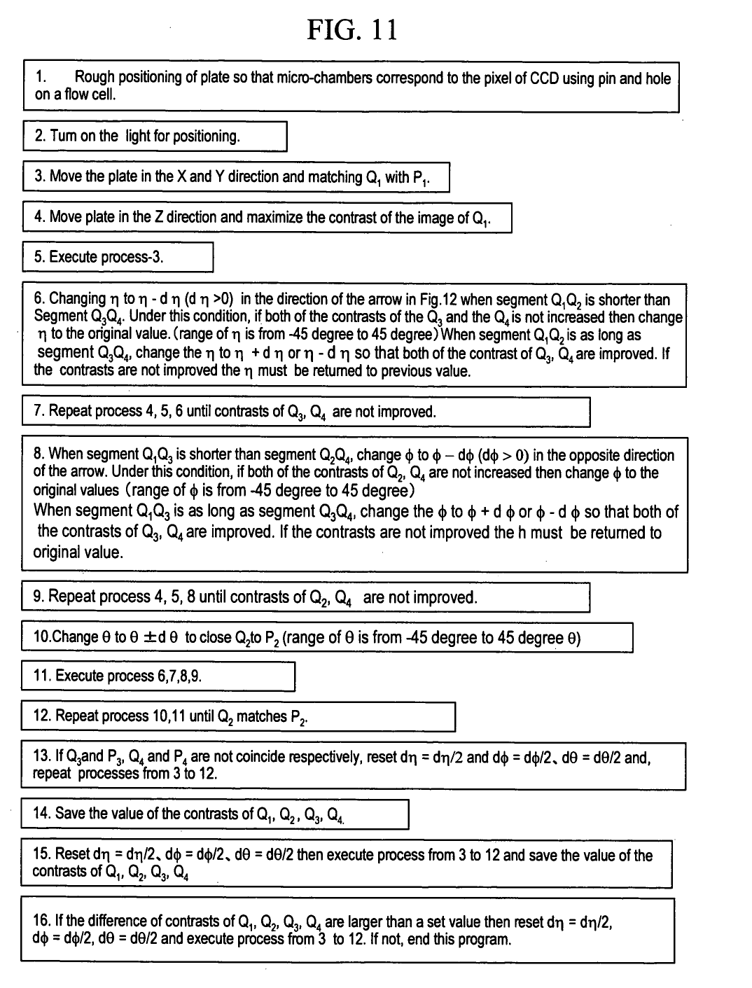

From a state in which the flow cell 101 has been mechanically located at an appropriate position to some degree, X, Y, Z, η, φ and θ will be adjusted according to the flow chart in FIG. 11. Therefore, at a stage before adjustment, the state in which the point nearest to Pᵢ with respect to the same i is Qᵢ has been achieved. In Formula 1, I[k, 1] denotes the intensity of light received at pixel [k, 1] and Max denotes a maximum value when [k, 1] is changed in the area Rᵢ corresponding to Qᵢ. The area Rᵢ here indicates ¼ areas at top left, top right, bottom left and bottom right of Q₁, Q₂, Q₃ and Q4 respectively in FIG. 10 in this embodiment. The item within parentheses in Formula 1 always takes a maximum value when [k, 1] is changed. When the position at which this maximum value is taken is made to correspond to the center of Qᵢ, alignment between Pᵢ and Qᵢ can be realized. Moreover, the value of this maximum value can generally be further increased by adjusting Z or the like and focus can be adjusted by maximizing the contrast function with respect to these parameters.

A more specific adjustment procedure is performed according to FIG. 11. First, the plate 202 is positioned using the concavo-convex structure and through-holes provided in the flow cell 101 so that the micro-reaction chambers in the plate 202 substantially correspond one-to-one with the pixels of the image pickup element 103 (process 1). Only this process is executed by the operator and other processes will be automatically executed by a CPU (not shown) according to a processing program stored in storage means (not shown).

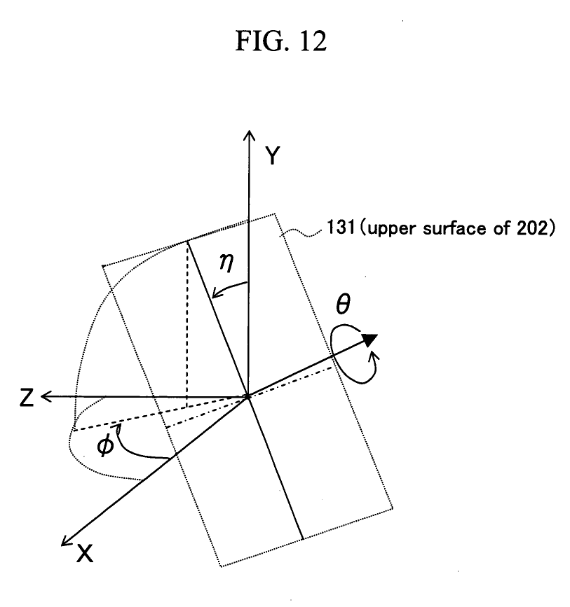

The light sources for alignment 90 are lit (process 2). Next, the flow cell 101 is moved in the x- and y-axis directions by driving the alignment mechanism 105 (driving part) to cause Q₁ to align with P₁ (process 3). Next, the flow cell 101 is moved in the z-axis direction to maximize the contrast of Q₁ (process 4). Since the position of the flow cell 101 shifts in the x- and y-axis directions when the flow cell 101 is moved in the z-axis direction, process 3 is executed again (process 5). In a word, the following operation is executed in processes 3 to 5. The contrast function is moved in such XYZ directions that the position of the flow cell is indicated by coordinates in FIG. 7. Furthermore, the center of Pᵢ is aligned with the center of Qᵢ by changing the inclination and rotation (η, φ, θ) of the plate 202 in the flow cell 101, contrast 1 (Qᵢ) corresponding to Qᵢ is maximized, and alignment and focus adjustment are executed. Here, FIG. 12 shows angles corresponding to the angle η, φ and θ. Reference numeral 131 denotes the plane corresponding to the plate plane. When the intersection between this plane and the YZ plane is assumed to be a Y′-axis and the intersection between the plane 131 and the XZ plane is assumed to be an X′-axis, suppose the angle formed by the Y-axis and Y′-axis is η and the angle formed by the X-axis and X′-axis is φ. Suppose θ denotes the rotation in the plane 131 of the array of micro-reaction chambers.

In this adjustment operation, η and φ can be adjusted preferentially according to the shape of arrangement of Qᵢ at four points (processes 6 and 8). The process of adjusting in a combination of X, Y, Z and θ precedes over the process of adjusting η or φ which would originally be executed if this process did not exist, and a true maximum value cannot be reached and there is a possibility that alignment and focus adjustment may be finished insufficiently. This process of judging whether or not to preferentially execute angle adjustment from the shape of arrangement of image Qᵢ on the CCD plane of a plurality of light-emitting points is a process indispensable to ensure that a true maximum value of the contrast function is reached and adjustment can be completed correctly.

After process 6, processes 4 to 6 are repeated until the contrast of Q₃ and Q₄ are no longer improved (process 7). Moreover, after process 8, processes 4, 5 and 8 are repeated until the contrast of Q₂ and Q₄ are no longer improved (process 9).

Next, Q₂ is brought closer to P₂ by moving θ by dθ (process 10). Next, processes 6 to 9 are executed (process 11). Furthermore, processes 10 and 11 are repeatedly executed so that Q₂ matches P₂ (process 12). If Q₃ does not match P₃ and Q₄ does not match P₄, dη=dη/2, dφ=dφ/2 and dθ=dθ/2 are set again and processes 3 to 12 are executed again (process 13).

When the contrast values of Q₁ to Q₄ are finally obtained, the values are saved in a memory (process 14). Moreover, dη=dη/2, dφ=dφ/2 and dθ=dθ/2 are set again, processes 3 to 12 are executed again and the contrast values of Q₁ to Q₄ are saved in the memory (process 15). Finally, if the difference in the contrast of Q₁ to Q₄ before and after process 15 is greater than a value set beforehand, dη=dη/2, dφ=dφ/2 and dθ=dθ/2 are set again and processes 3 to 12 are executed again. Otherwise, the adjustment processing is finished (process 16).

In the adjustment processing shown in the flow chart of FIG. 11, the processing order is selected by measuring the distance of QᵢQⱼ, but there are various possibilities other than this. For the calculation of the distance of QᵢQⱼ, the values derived from the corresponding coordinates and Pythagorean theorem are used. The expression “substantially equal” means a case where the difference is ½ pixel or less. Moreover, dη, dφ and dθ set beforehand which are described in the flow chart are each assumed to be 0.01 radians, but it is needless to say that the size of micro-reaction chambers or the like should be corrected. Furthermore, it is assumed here that the number of light-emitting points 90 is four, but the number may be greater if it is at least three.

### (6) Configuration of Light-Emitting Points

In the above described alignment processing, luminescence intensities at the plurality of light-emitting points 90 should substantially match and should not change timewise. To realize such luminescence, there are various methods like (i) a method of introducing a light-emitting device into the multi-well titerplate, (ii) a method of arranging the lighting opposite to the image pickup element with respect to the multi-well titerplate to enable the light from this lighting to be observed only at the part corresponding to the light-emitting point of the multi-well titerplate, (iii) a method of arranging the lighting on the same side as the image pickup element with respect to the multi-well titerplate and arranging a reflector at the position corresponding to the light-emitting point to enable the light to enter the image pickup element to enable illumination light to enter the image pickup element more effectively than the other areas on the multi-well titerplate. Hereinafter, more specific methods will be explained.

FIG. 13 shows a cross-sectional view of the multi-well titerplate in the flow cell provided with the light-emitting points. The position of the section is straight line AA′ in FIG. 9. FIGS. 13(a) to (c) correspond to the above described methods (i) to (iii) respectively.

First, the cross section of the multi-well titerplate 71 in the case (i) is shown (see FIG. 13(a)). Polycarbonate is used as the plate material. As shown in the figure, green light-emitting diodes 72 in the plate 71 are arranged in concave parts 73 of the back side shaped so as to correspond to the positions of the light-emitting points. The reason that the light-emitting diodes are used is that the light-emitting diodes have a short coherence length and high light-emitting efficiency and produce less heat, and can thereby prevent the temperature of the micro-reaction chambers from increasing. Furthermore, the reason that the green color is used is to reduce influences of chromatic aberration during focus adjustment by using a wavelength equivalent to that of bioluminescence. A constant current is passed through the light-emitting diodes and a constant current source 83 is connected thereto so that light of constant intensity is emitted. Through-holes 74 having a diameter of approximately 10 μm are provided at appropriate positions of the concave parts so that isotropic luminescence can be obtained from small areas near the surface of the multi-well titerplate. To prevent leakage from the through-holes 74, these holes are sealed with a transparent resin adhesive in which a glass bead of 1 μm in diameter is mixed. Since light does not pass through any aluminum vapor-deposited layer, the light which has passed through the through-holes and scattered is imaged. Since the size of the through-holes 74 is the size of light-emitting points, the through-holes 74 having a diameter smaller than the pixel size of 20 μm are formed. Here, polypropylene polymethyl methacrylate polyethylene resin or the like may be used as the plate material. Furthermore, other metal materials may also be used as the vapor-deposited material. Furthermore, the plate material may be prepared using metal such as stainless steel. In this case, no vapor-deposited layer for the concave parts is necessary.

Next, the cross section of the multi-well titerplate 75 in the case (ii) is shown (see FIG. 13(b)). In FIG. 13(b), reference numeral 76 denotes a backlight made up of a fluorescent lamp. Here, the image pickup element is arranged on the opposite side across the plate 75, aluminum deposition of approximately 2 μm in thickness is applied to the back side thereof and a vapor-deposited layer 77 is formed. The concave part 78 was formed on the back side of the light-emitting point and the through-hole 74 of 10 μm in diameter was formed at the position of the light-emitting point. The through-holes are sealed with the transparent adhesive 84 with beads mixed therein as described above. Optical or plastic fibers through which light passes are arranged at the corresponding positions of the light-emitting points. As other configurations, a transparent resin material (e.g., polycarbonate) may also be shaped so as to fit the concave parts 78 and adhered thereto.

Finally, the cross section of the multi-well titerplate 80 in the case (iii) will be shown (see FIG. 13(c)). In FIG. 13(c), reference numeral 81 denotes a light source for lighting. A green light-emitting diode having a wavelength equivalent to that of chemical luminescence is used as the light source. However, various lamps may also be used. Here, to improve the accuracy of focus alignment, a green light-emitting diode which emits light at the wavelength is used as the light source 81. The image pickup element is arranged on the same side as the lamp 81 with respect to the plate 80. Silica beads 82 of 10 μm in diameter were arranged as scatterers at the positions corresponding to the four light-emitting points so as to protrude several μm above from the surface of the plate. Actually, the beads were arranged and fixed using a transparent adhesive assuming that the micro-reaction chambers 83 at the positions of the light-emitting points is 5 μm.

The reflector may be made of a glass material, metal or resin material, and the shape may also be a column or rectangular parallelepiped instead of a spherical shape. In order to improve the contrast at points other than the light-emitting points, the plate 80 was prepared using a resin material containing black pigment so as to suppress reflections of light at any points other than the light-emitting points on the surface of the plate. Antireflection treatment may also be performed for the same purpose. Furthermore, to improve the contrast, it is also possible to mix micro semiconductor particles (semiconductor particles of ZnSe of several nm to several tens of nm called “Quantum Dot”), use a laser as the light source and use fluorescence from the beads as the light-emitting points. Semiconductor particles do not produce color fading and are suitable for adjustment by irradiating laser light for a long time. In this case, a light source having a wavelength shorter than the wavelength of luminescence is used for laser excitation and a band stop filter for cutting this wavelength is used between the image pickup element and the plate 80.

Next, the arrangement in the system will be explained about the above described three light-emitting schemes. The system configuration of this embodiment is shown in FIG. 7, and this corresponds to the transmission scheme in (ii). Reference numeral 87 denotes a window having a diameter smaller than the pixel size through which light of the backlight passes and corresponds to the through-hole 74 sealed with an adhesive 84 in FIG. 13. An optical fiber may also be used for 87. In the case of the light-emitting scheme in (i), the light-emitting diode may also be arranged on the opposite side of the image pickup element. Since the configuration is the same as that in FIG. 7, illustrations thereof will be omitted.

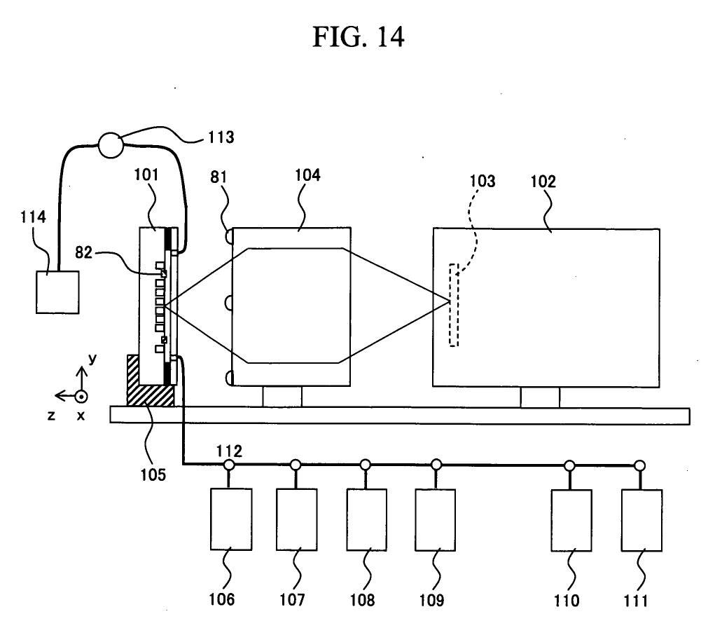

On the other hand, FIG. 14 shows a system configuration when the above described light-emitting scheme in (iii) is used. A reflector 82 is arranged in the plate 202 and light-emitting diodes 81 are arranged around the lens 104. Lighting should be provided so as not to shield bioluminescence and the reflector should be irradiated at uniform light intensity. Therefore, a certain relationship should be established between the arrangement of the reflector and arrangement of the light-emitting diodes for lighting.

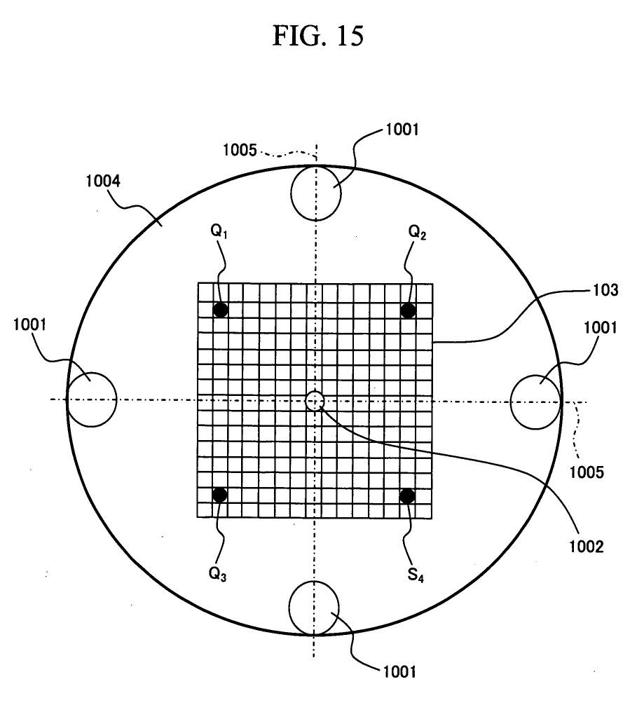

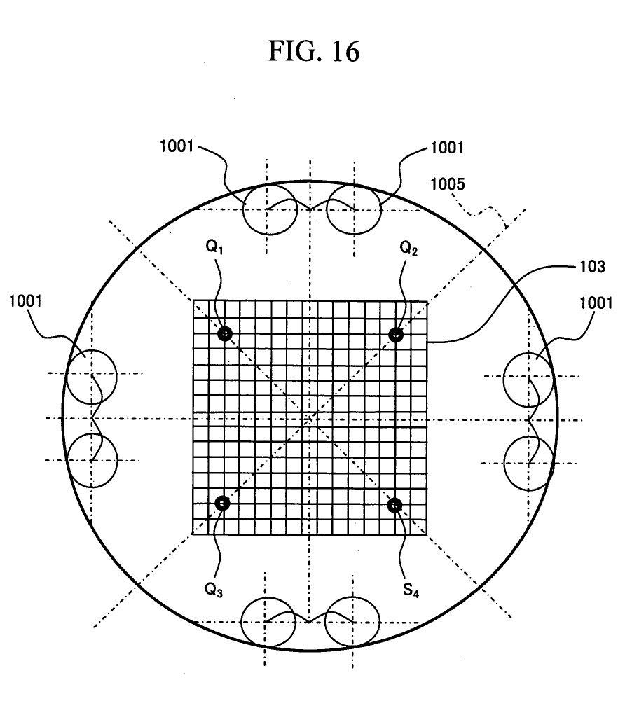

As shown in FIG. 9, when the reflectors are arranged in a square shape, the diodes should also be arranged to be 4n-fold (n: natural number) symmetric so as to match the symmetry of the reflector arrangement. FIGS. 15 and 16 show examples of diode arrangement when n=1. In the figure, reference numeral 1001 denotes a light-emitting diode for lighting. The diode 1001 is fixed to an outer frame 1004 of the lens 104. Each figure shows a view seen from an extension of an axis 1002 connecting the center of the image pickup element 103 and the center of the lens 104.

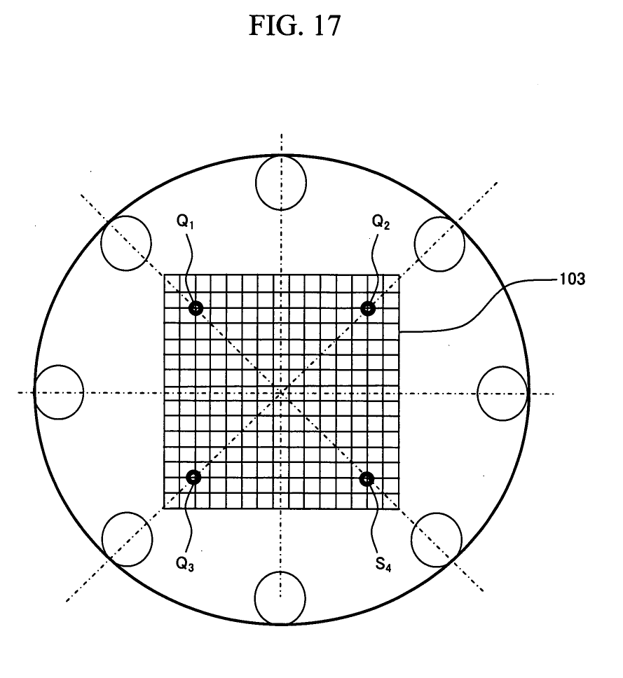

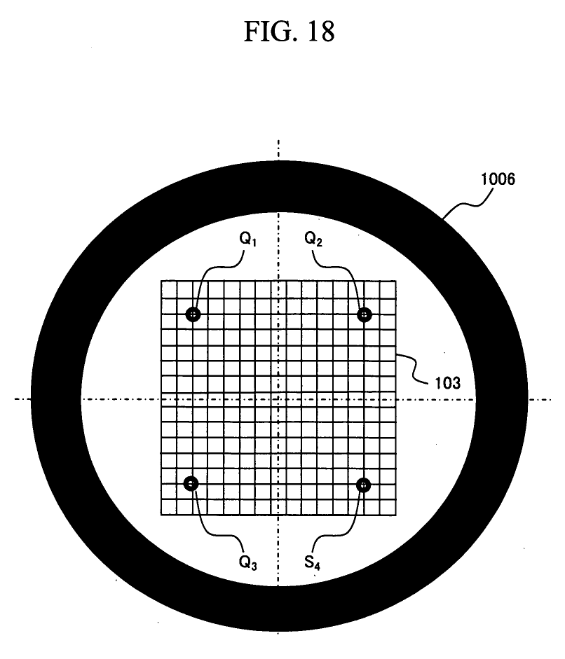

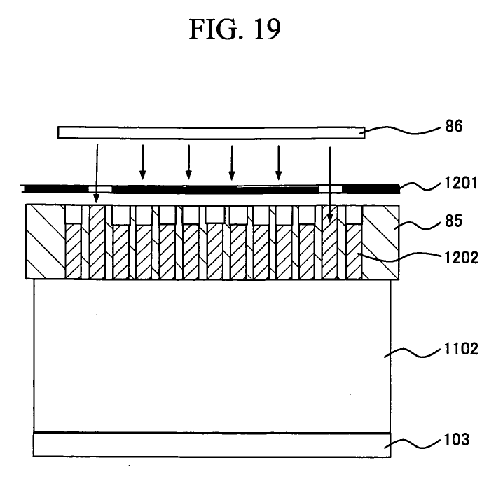

Furthermore, in FIG. 15, Qᵢ denotes an image at a reflection point, showing a state in which alignment and focus adjustment have been correctly completed. The light-emitting diodes are arranged so as to be 4-fold symmetric (axis of symmetry 1005). On the other hand, FIG. 16 shows a case where diode arrangement is likewise 4-fold symmetric and the number of diodes is 8. Likewise, FIG. 17 shows a case where diode arrangement is 8-fold symmetric and FIG. 19 realizes a case of n=∞ using a ring-shaped lighting apparatus 1006.

Various lighting methods are possible if the above described requirements of symmetry are satisfied. If the light-emitting diodes that do not satisfy these symmetrical requirements are arranged, the same intensity of luminescence from the reflection point can no longer be obtained, a great difference is produced in the contrast corresponding to Qᵢ and the accuracy of adjustment of η and θ deteriorates. Deterioration of accuracy may also occur when the contrast remains in a maximum value in the contrast maximization process and may also lead to drastic deterioration of accuracy of alignment depending on the operating conditions.

### (7) Features of Optical System

The condition necessary for the optical system in this embodiment is to efficiently guide the light emitted from the micro-reaction chambers 201 only to specific pixels and not to guide the light to other pixels. The most common method of achieving this is preferably one that efficiently forms an image of luminescence from the micro-reaction chambers in the image pickup element 103 using the lens system 104 having a small F value as shown in FIG. 7. The lens having a small F value is used to make it possible to efficiently measure luminescence even if the luminescence is dark.

However, if a combination lens such as a camera lens is used for optical system 104, distortion of the image occurs and it is not possible to make the positions of all the micro-reaction chambers in the plate align with the positions of all the pixels in a simple configuration.

Therefore, a rod lens array or micro lens array and optical fiber bundle may also be used in the third embodiment as well as the first and second embodiments.

In this case, adjustment of focus and the adjustment of angles φ and η become unnecessary. However, adjustment of X, Y and θ in the plane is performed using the above described process. Moreover, it is also possible to measure one flow cell using a plurality of image pickup elements using a plurality of these optical fiber bundles or a branched optical fiber bundle.

### (8) Others

As a modification example, a fiber optic plate may be used for the multi-well titerplate 202 and light from the micro-reaction chambers 201 may be measured from the back of the plate 202. Light is measured from the back of the plate in the case of Non-Patent Document 2, but the micro-reaction chambers do not correspond one-to-one with pixels of the image pickup element.

However, even when light is measured from the back of the plate 202, the pixels and reaction chambers 201 can be made to correspond one-to-one with each other only through in-plane displacement and rotation by θ of the multi-well titerplate 202 with respect to the image pickup element 103 if the configuration of this embodiment (alignment mechanism 105 and alignment operation (FIG. 11)) is provided.

FIG. 19 is a cross-sectional view showing the configuration for realizing one-to-one alignment in a modification example. In this case, since a fiber optic plate 85 is optically transparent, if a backlight 86 (corresponds to 76 in FIG. 13(b)) is used, light should be made to impinge on part of the plate 85. That is, the top plate of a flow cell 1201 is made optically transparent only in areas 1202 (correspond to light transmission window 87) at specific positions corresponding to the light-emitting points and made to reflect or absorb light in other areas (areas 1201 painted in black) so as not to allow light to pass through. There is an optical fiber (core) of an optical fiber bundle 1102 right under all the micro-reaction chambers 201, which also transmits light from the backlight 86 as well as chemical luminescence to an image pickup element 103. Of course, light-emitting diodes may also be used.

Moreover, a grating or a prism may be inserted into the lens system 104 to change detecting pixels depending on the light-emitting wavelength. In this case, when the light-emitting wavelengths of dATP, dTTP, dCTP and dTTP are different, this embodiment makes it possible to identify which base emits light at the position of a pixel that detects luminescence. In a word, fluorescent materials of different wavelengths for four types of dNTP are introduced, a reagent is put at a time to identify which base has extended by wavelength. The type of dNTP is identified in correspondence with a pixel which varies from one wavelength to another. However, when wavelength resolution does not take place, in the same way that one reaction chamber is made to correspond to one pixel, even if the reaction chamber is the same, if the wavelength is different, the wavelength should be made measurable by a different pixel to avoid crosstalk in this modification example. This enables a base array to be determined with high throughput and high accuracy. Describing more specifically, when one type of dNTP is put to cause extension reaction, the type of base is judged by whether or not extension reaction takes place, and on the other hand, in this modification example, only one base is allowed to extend and the type of base is made distinguishable by wavelength. This eliminates any such step that extension does occur even when a reagent is put, and therefore the analysis time is reduced by half (when the reagent is deposited one type at a time, if the array is random, extension reaction occurs at a probability of approximately 50%). Thus, the number of times the reagent is deposited is reduced by half, the analysis time is reduced by half and throughput improves two-fold.

### Fourth Embodiment

The third embodiment has shown an example where alignment is realized in such a way that one light-emitting point 90 is made to correspond to one pixel. This embodiment shows an example where alignment is realized by making one light-emitting point correspond to four pixels.

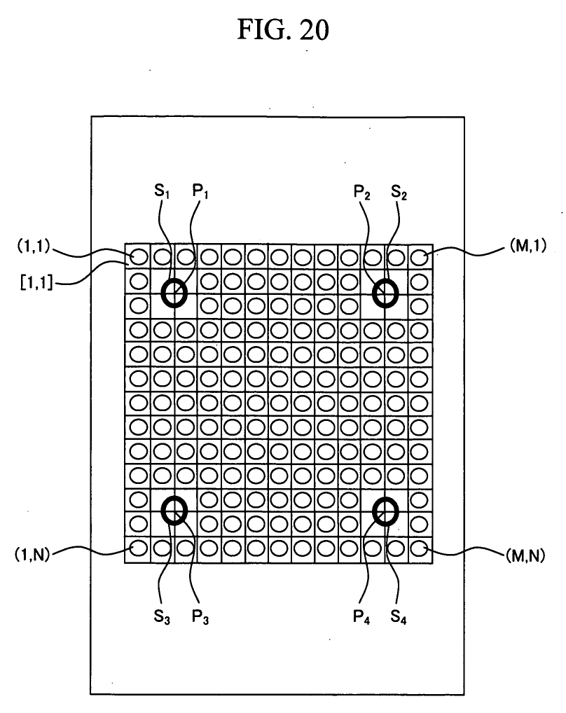

FIG. 20 shows a relationship between the arrangement of micro-reaction chambers 201 and light-emitting points, and the arrangement of pixels of the image pickup element. If light-emitting point Sᵢ is placed in the center of four micro-reaction chambers 201 and the center of image Qᵢ of the light-emitting point is adjusted correctly (light intensities of four pixels are equalized), Sᵢ matches boundary point Pᵢ of four pixels. Thus, by placing a light-emitting point at a position shifted from the positions at which the micro-reaction chambers are located, it is possible to define the following contrast function.

### [Formula 2]

$$\begin{matrix}Formula 2 & \\ {( Contranst 2 ( {Q}_{i} ) )}^{- 1} = {Min}_{[ k , l ] ∈ {R}_{i}} \frac{\vert I [ k , l ] - I [ k - 1 , l ] \vert + \vert I [ k , l ] - I [ k , l - 1 ] \vert}{\vert I [ k , l ] + I [ k - 1 , l ] \vert + \vert I [ k , l ] + I [ k , l - 1 ] \vert} & ( 2 )\end{matrix}$$

Here, when correctly adjusted, the value of this contrast function diverges, and so a reciprocal is taken and the reciprocal is adjusted so as to approximate to minimization (that is, 0). Therefore, when the processing shown in the flow chart of FIG. 11 is executed, the processing is executed by reading “maximizing of the contrast function” as “minimizing of the reciprocal of the contrast function.” Furthermore, in this Formula 2, Pᵢ is [k−½, 1−½] (k=3, M−1, 1=3, N−1) and corresponds to each of boundary points of four pixels.

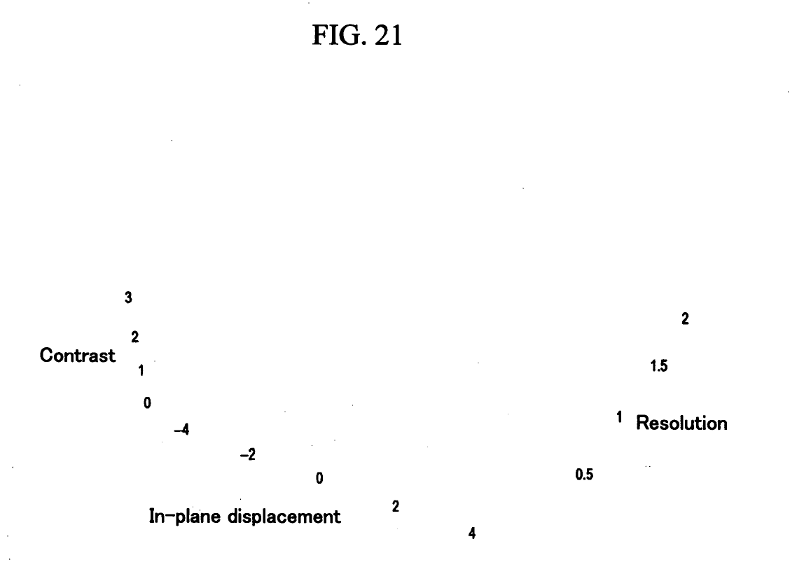

In this way, the contrast function that can be defined by arranging the light-emitting points at the boundary points displays an excellent characteristic as will be explained below. For a comparison, FIG. 21 shows a plotting of values of Formula (1) as a function of the amount of in-plane displacement (displacement in the X or Y direction when the angle is not adjusted) of Qi with respect to Pᵢ and resolution (parameter corresponding to focus, which approximates to 0 when focus is shifted or a light-emitting point expands and resolution is defined to be 1 when focus is achieved, the center of the image at the light-emitting point aligns with the center of the pixel and light intensity at the edge of the pixel becomes 1/e). There are a plurality of maximum values in FIG. 21 and it is obvious from the figure that when alignment and focusing are performed, there is a possibility that optimization may end with a local maximum value.

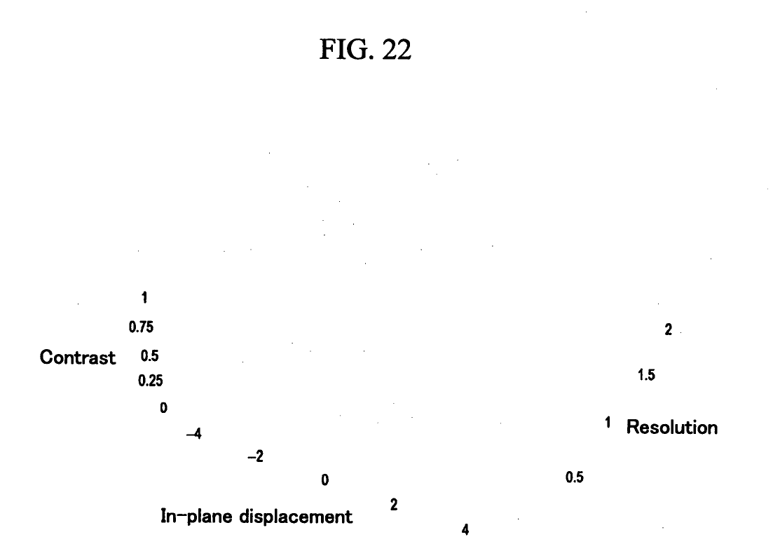

Similarly, the values of Formula (2) are plotted in FIG. 22. This case shows minimization instead of maximization, and there is only one minimum value and there is no possibility that optimization may end midway. Therefore, it is understood that such arrangement of light-emitting points enables alignment with high accuracy.

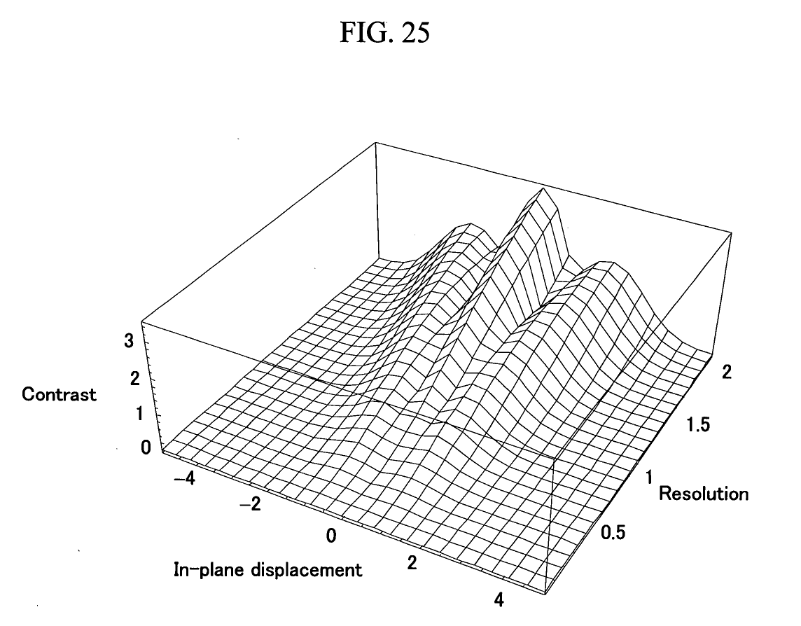

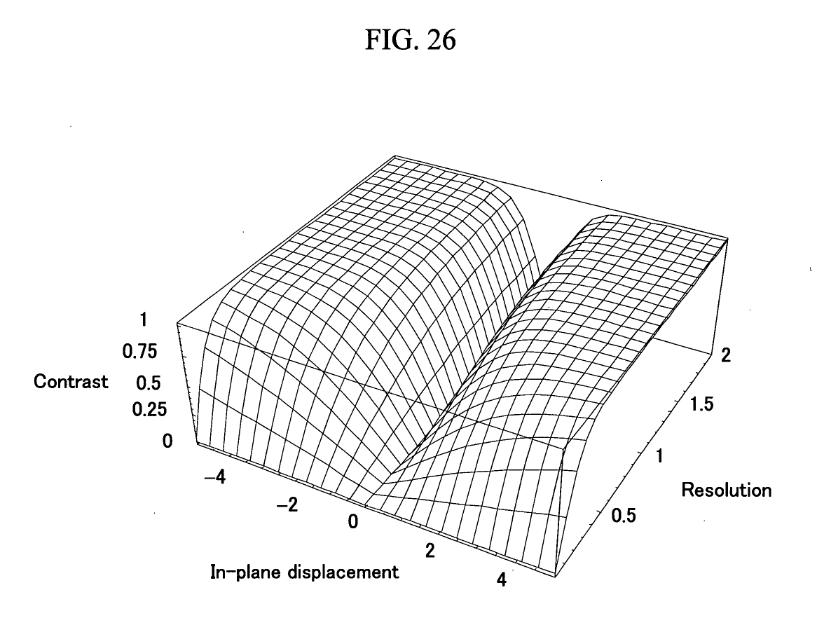

FIGS. 25 and 26 are the same drawings as FIGS. 21 and 22, which show contour plans of three-dimensional wire frame respectively. FIGS. 25 and 26 have been added to make the graphs on the resolution of contrast and the amount of in-plane displacement shown in FIG. 21 and 22 easy to see.

### Fifth Embodiment

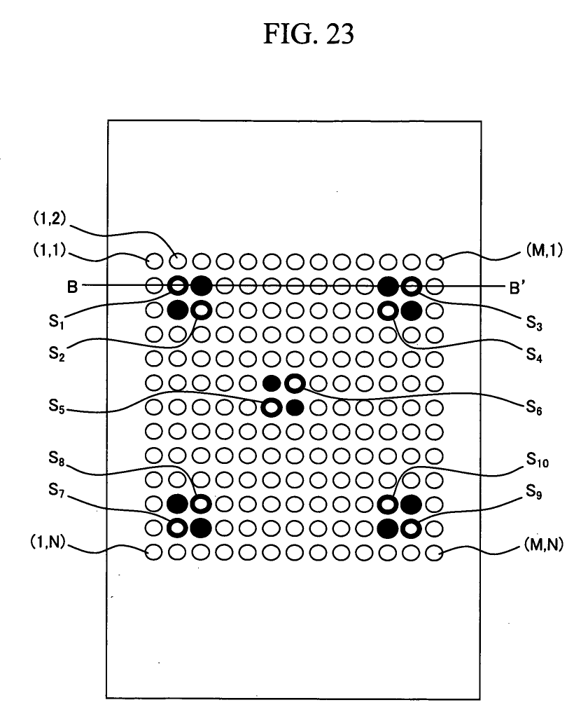

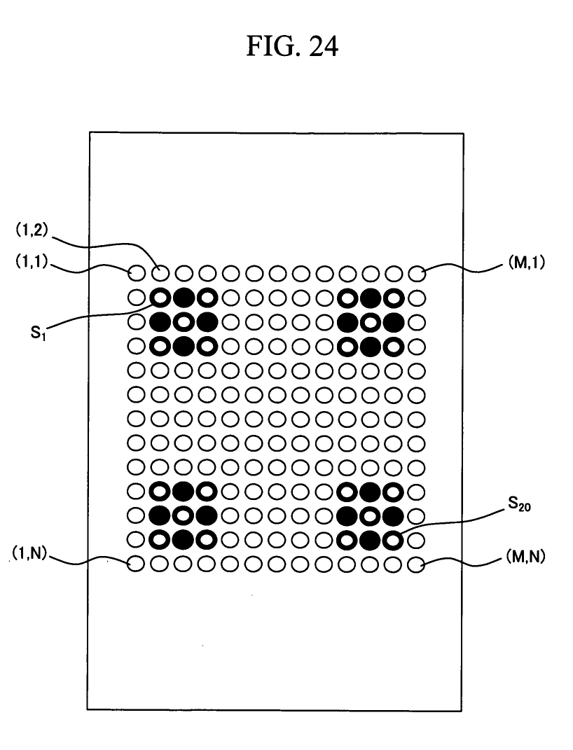

A fifth embodiment shows an example where the number of light-emitting points is increased instead of four. FIG. 23 and FIG. 24 show an arrangement relationship between micro-reaction chambers 201 and light-emitting points respectively. In FIG. 23, light-emitting points S₁ to S₁₀ are arranged. On the other hand, in FIG. 24, light-emitting points S₁ to S₂₀ are arranged.

Furthermore, in these examples, the accuracy of a contrast function value is improved and accuracy of alignment is improved by arranging points at which luminescence is further reduced compared to the periphery (circles painted in black) at positions of some micro-reaction chambers 201 around the light-emitting points. The black painted parts in FIGS. 23 and 24 correspond to the points at which luminescence, reflection and the transmission of light are intentionally suppressed.

In addition, it is more effective to define a contrast function by grouping instead of individually defining light-emitting points for alignment.

### [Formula 3]

$$\begin{matrix}Formula 3 & \\ Contranst 3 ( {Q}_{groupi} ) = {Max}_{[ k , l ] ∈ Ri} ( \begin{matrix}\vert I [ k , l ] - I [ k - 1 , l ] \vert + \vert I [ k , l - 1 ] - I [ k - 1 , l - 1 ] \vert + \\ \vert I [ k - 1 , l ] - I [ k - 1 , l - 1 ] \vert + \vert I [ k , l - 1 ] - I [ k , l ] \vert\end{matrix} ) & ( 3 )\end{matrix}$$

### <Conclusion>

The chemiluminescent detection system of each embodiment detects chemical luminescence from reaction chambers using a nucleic acid analysis, phased synthesis of complementary strands in particular. A gene array analysis is executed using the detection result.

According to the chemiluminescent detection system of each embodiment, a plurality of reaction chambers and pixels of the image-pickup element correspond one-to-one with each other and the detected image is free of distortion. Therefore, the number of reaction chambers defined can be increased to the utmost and an analysis throughput can be analyzed precisely. Moreover, because the number of DNA samples which can be analyzed at a time can be increased to the number of pixels of a detection element, and it is thereby possible to manufacture the system at low cost, too.

What is claimed is:

1. A chemiluminescent detection system that detects light from a plurality of reaction chambers, comprising:
a flow cell having a plate on which a plurality of reaction chambers are arranged one-dimensionally or two-dimensionally;
optical detection means having a plurality of pixels; and
an optical system for forming images of the plurality of reaction chambers in the optical detection means, with a spacing of pixels of the optical detection means substantially matching a spacing of the reaction chambers on the plate,
wherein luminescence from the plurality of individual reaction chambers is detected in a one-to-one correspondence with different pixels of the optical detection means.

2. The chemiluminescent detection system according to claim 1, wherein the optical system comprises an optical lens for forming images of the reaction chambers as 1× erecting images in the optical detection means.

3. The chemiluminescent detection system according to claim 2, wherein the size of the erecting images of the reaction chambers is smaller than the size of pixels of the optical detection means.

4. The chemiluminescent detection system according to claim 1, wherein the reaction chambers and the optical detection means are spatially separated, and
the optical system comprises a rod lens array.

5. The chemiluminescent detection system according to claim 4, wherein a depth of field of the rod lens array is greater than the depth of the reaction chambers.

6. The chemiluminescent detection system according to claim 1, wherein the reaction chambers and the optical detection means are spatially separated, and
the optical system comprises an optical fiber bundle or micro lens array.

7. The chemiluminescent detection system according to claim 1, further comprising positioning means having a mechanism that fixes the flow cell to the optical system for determining a relative positional relationship when making the reaction chambers of the plate correspond one-to-one with pixels of the optical detection means.

8. The chemiluminescent detection system according to claim 1, further comprising alignment means for adjusting a positional relationship of the plate with respect to the optical detection means based on the detection result of the optical detection means.

9. The chemiluminescent detection system according to claim 8, wherein the plate comprises a plurality of light-emitting elements, and
the alignment means adjusts the positional relationship based on the detection result of light from the plurality of light-emitting elements.

10. The chemiluminescent detection system according to claim 8, wherein the plate comprises a plurality of reflectors with high reflectivity of light,
the reflectors comprise lighting means for irradiating light, and
the alignment means adjusts the positional relationship based on the detection result of the reflected light from the reflectors.

11. The chemiluminescent detection system according to claim 8, wherein the plate comprises a light transmission part,
further comprises lighting means for irradiating light from the back of the plate, and
the alignment means adjusts the positional relationship based on the detection result of transmitted light from the light transmission part.

12. The chemiluminescent detection system according to claim 9, wherein the center of luminescence of the light-emitting element is arranged between the plurality of reaction chambers on the plate.

13. The chemiluminescent detection system according to claim 10, wherein the center of the reflectors is arranged between the plurality of reaction chambers on the plate.

14. The chemiluminescent detection system according to claim 11, wherein the center of the light transmission part is arranged between the plurality of reaction chambers on the plate.

15. The chemiluminescent detection system according to claim 9, wherein the alignment means adjusts the positional relationship while judging whether or not to preferentially execute angle adjustment of the plate based on the detection result of light from the plurality of light-emitting elements.

16. The chemiluminescent detection system according to claim 10, wherein the alignment means adjusts the positional relationship while judging whether or not to preferentially execute angle adjustment of the plate based on the detection result of light from the plurality of reflectors.

17. The chemiluminescent detection system according to claim 11, wherein the alignment means adjusts the positional relationship while judging whether or not to preferentially execute angle adjustment of the plate based on the detection result of transmitted light from the light transmission part.

18. The chemiluminescent detection system according to claim 1, further comprising means for supplying at least four types of nucleic acid and cleaning solution to the plurality of reaction chambers.

19. The chemiluminescent detection system according to claim 1, wherein the optical detection means is a CCD array sensor or MOS array sensor whose pixel size is 1 to 30 microns or flat panel sensor manufactured on a glass substrate whose pixel size is 30 to 150 microns.

20. The chemiluminescent detection system according to claim 1, wherein the plurality of reaction chambers comprise DNA samples fixed to beads, having a function of enabling synthesis reaction of complementary strand to be executed in the same condition and then enabling luminescence reaction to continue.
